(19) United States
(12) Patent Application Publication
(10) Pub. No.: US 2005/0063754 A1
(43) Pub. Date: Mar. 24, 2005

(54) REEL TABLE AND RECORDING DEVICE WHEREIN THE REEL TABLE IS USED

(75) Inventors: Yoshiharu AKASHI, Daito-shi, Osaka (JP); Takahiro OKUIE, Nara-shi, Nara (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Osaka (JP)

(21) Appl. No.: 10/711,474

(22) Filed: Sep. 21, 2004

(30) Foreign Application Priority Data
Sep. 24, 2003 (JP) 2003-330922

(51) Int. Cl. B41J 35/28

(52) U.S. Cl. 400/208

(57) ABSTRACT

A recording device has a main body for inserting thereinto an ink cartridge having a take-up roller for winding up an ink sheet. The device comprises a reel table provided inside the main body and engageable with the take-up roller, the reel table being provided on a peripheral surface thereof with a plurality of ridges engageable with the take-up roller. Each of the ridges comprises a tapered end portion having a sharp end and a straight portion integral with the tapered portion and having a side face to be brought into contact with the take-up roller. One of the ridges is approximately equal to the other ridges in the length Y1 of the straight portion, and the tapered portion of the above-mentioned one ridge integral with the straight portion has a height Y2 greater than the height Y3 of the tapered portions of the other ridges.

### FIELD OF THE INVENTION

The present invention relates to reel tables for rotating a member to be engaged and recording devices wherein the reel table is used, and more particularly to thermal recording devices, such as thermal transfer recording devices and thermal sublimation recording devices, for thermally printing images on recording paper with use of an ink cartridge.

### BACKGROUND OF THE INVENTION

Thermal recording devices, such as thermal transfer recording devices and thermal sublimation recording devices, have been proposed for printing on recording paper image data obtained by a personal computer or digital camera. For printing images on recording paper by such thermal recording devices, an ink cartridge 6 shown in FIG. 8 is used as removably inserted in the device. For example, a thermal sublimation recording device will be described below.

The cartridge 6 comprises a take-up roller 7 and a supply roller 61 provided as spaced apart in a cartridge body 60, and an ink sheet 62 is reeved around the two rollers 61, 7. Between the two rollers 61, 7, the cartridge body 60 has an opening 63 for a thermal head 5 to be described later to advance into the cartridge therethrough.

FIG. 9 is a perspective view showing the two rollers 61, 7, and FIG. 10 is a plan view in section of the device into which the cartridge 6 is to be inserted. The ink cartridge 6 is removably inserted into the main body 3 of the device through an opening 30 formed in a side plate 31 of the device main body 3. Arranged inside the device main body 3 are a platen roller 4 for transporting recording paper 40, and a thermal head 5 for heating the ink sheet 62, which is positioned between the thermal head 5 and the recording paper 40.

With reference to FIG. 9, the ink sheet 62 has ink coatings of three colors, i.e., yellow Y, magenta M and cyan C, as arranged in the winding direction. The recording paper 40 is moved by the platen roller 4 in parallel to the ink sheet winding direction. Nip rollers (not shown) are arranged at the upstream or downstream side of the recording paper 40, and the paper 40 is transported by the platen roller 4, as held taut by the nip rollers. The thermal head 5 is connected to an image processing circuit 50, which feeds to the thermal head 5 image data corresponding to the respective colors of yellow, magenta and cyan.

For printing, the platen roller 4 is rotated to oppose the thermal head 5 to a position on the recording paper 40 where the first image is to be printed. The take-up roller 7 is rotated to position the leading end of yellow as opposed to the thermal head 5. The thermal head 5 is heated as positioned close to the ink sheet 62.

Image data corresponding to yellow is first sent to the thermal head 5 from the image processing circuit 50. Since the thermal head 5 is heated, the ink sheet 62 is heated to sublime the yellow ink. The image data of yellow component is printed on the recording paper 40 by rotating the take-up roller 7 and the platen roller 4 in a direction to feed the ink sheet 62. When the yellow component is completely printed, the thermal head 5 is moved away from the platen roller 4, and the platen roller 4 is rotated to return the recording paper 40 to the initial position. Image data corresponding to magenta is then sent to the thermal head 5, and the take-up roller 7 and the platen roller 4 are rotated in the direction of feeding the ink sheet 62. The image data of magenta component is printed on the recording paper 40. Image data corresponding to cyan is thereafter printed on the paper 40 in the same manner as above. On completion of printing of the three colors, the thermal head 5 is moved away from the platen roller 4, and the platen roller 4 is rotated to discharge the recording paper 40 from the device (see Japanese Patent No. 3404699).

Provided in an interior rear portion of the device main body 3 shown in FIG. 10 is a reel table 1 fittable to one end of the take-up roller 7 inside the cartridge 6 for rotating the take-up roller 7. As shown in FIG. 11, the reel table 1 is slidably fitted to a rod 34 mounted on the side plate 31 of the device main body 3, and is biased toward the ink cartridge 6 by a compression spring 35 provided around the rod 34.

The reel table 1 can be of various constructions. An example of reel table comprises, as mounted on a shaft 14, a reel spindle 2 fittable to the take-up roller 7, a compression spring 10 and a take-up gear 11 to be driven by an unillustrated motor (see JP-A No. 5-305759). Arranged on opposite sides of the take-up gear 11 are holding plates 12, 12 connected to the reel spindle 2 by the shaft 14 and felt members 13, 13. The compression spring 10, holding plates 2, 12 and felt members 13, 13 provide a slip mechanism already known. When the take-up gear 11 is driven by the motor for rotation, slippage occurs between the gear 11 and the felt members 13, 13, causing a predetermined torque to rotate the holding plates 12, 12 and the reel spindle 2.

The reel spindle 2 has three first ridges 20, 20, 20 on its periphery. Each first ridge 20 has a tapered end portion 21 having a sharp end and a straight portion 22 integral with the tapered portion 21. The three first ridges 20, 20, 20 are equal in the length of the straight portion 22, as well as of the tapered portion 21 extending from the straight portion 22.

FIG. 12 shows the take-up roller 7 as seen from the direction A indicated in FIG. 10. Provided inside the take-up roller 7 are three second ridges 70, 70, 70 each adapted to contact at a side face thereof with that of the corresponding first ridge 20 of the reel spindle 2. The take-up roller 7 fits in a hollow portion 64 formed in the ink cartridge 6 while being allowed to play radially thereof.

The second ridge 70 has a sharp end [see FIG. 7(a)]. When the ink cartridge 6 is moved toward the reel table 1 for fitting, each second ridge 70 comes into contact with the first ridge 20 end-to-end, thereafter moves along the tapered end portion 21 of the first ridge 20 and brings a side face thereof into engagement with that of the first ridge 20.

With the reel table 1 fitted to the take-up roller 7, the second ridges 70 are in contact with the respective first ridges 20, each on the same side as shown in FIG. 13(a), i.e., on the counterclockwise side in FIG. 13(a). If the reel spindle 2 rotates with a given torque, the take-up roller 7 consequently rotates to wind up the ink sheet 62.

However, the construction described above has the following problem.

As described above, the take-up roller 7 fits in the ink cartridge 6 while being allowed to play radially thereof. Accordingly, if the take-up roller 7 inadvertently backlashes after the second ridges 70 come into contact with the respective first ridges 20 end-to-end, only one of the second ridges 70, unlike the other second ridges 70, is likely to contact the opposite side (clockwise side) of the first ridge 20. Then the rotation of the reel table 1 is not transmitted to the take-up roller 7 properly, and the ink sheet will not be wound up with good stability. The state shown in FIG. 13(b) is likely to occur especially if the ink cartridge 6 is inserted as slanted.

An object of the present invention is to transmit the rotation of a reel table 1 accurately to another member, i.e., to a take-up roller 7.

### SUMMARY OF THE INVENTION

The present invention provides a recording device having a main body 3 into which an ink cartridge 6 having a take-up roller 7 for winding up an ink sheet 62 is to be inserted. The recording device comprises a reel table 1 provided inside the main body 3 and engageable with the take-up roller 7, the reel table 1 being provided on a peripheral surface thereof with a plurality of ridges 20, 20a, 20b engageable with the take-up roller 7, each of the ridges 20, 20a, 20b comprising a tapered end portion 21 having a sharp end and a straight portion 22 integral with the tapered portion 21 and having a side face to be brought into contact with the take-up roller 7.

One of the ridges, 20, is approximately equal to the other ridges 20a, 20b in the length Y1 of the straight portion 22, and the tapered portion 21 of the ridge 20 which portion is integral with the straight portion 22 has a height Y2 greater than the height Y3 of the tapered portions 21 of the other ridges 20a, 20b.

The ridges 20, 20a, 20b of the reel table 1 are all approximately equal in the length Y1 of the straight portion 22. Accordingly, the portions of the ridges to be brought into contact and engagement with the take-up roller 7 are all equal in length, and are therefore engageable with the roller 7 with good stability.

Further the tapered portion 21 of one of the ridges, 20, which portion 21 is integral with the straight portion 22 has a height Y2 greater than the height Y3 of the tapered portions 21 of the other ridges 20a, 20b.

Accordingly, when the tapered portion 21 of the ridge 20 comes into contact with one of the second ridges 70 of the take-up roller 7 as shown in FIG. 7(a) upon insertion of the ink cartridge 6, the other ridges 20a, 20b are still out of contact with the other second ridges 70 of the take-up roller 7 as shown in FIG. 7(b). The reel table 1 is slightly rotated by the contact of the tapered portion 21 of the ridge 20 with the second ridge 70 of the roller 7, and when the ink cartridge 6 is further inserted, the side faces of the other ridges 20a, 20b are properly brought into contact with the other second ridges 70 of the roller 7. Thus, the ridge 20 guides the roller 7 to enable the other ridges 20a, 20b to come into proper engagement with the take-up roller 7. This brings the reel table 1 into proper engagement with the take-up roller 7 to properly transmit the rotation of the reel table 1 to the roller 7, hence a stabilized winding-up operation.

### BRIEF DESCRIPTION OF THE DRAWINGS

FIG. 1 is an exploded perspective view of a thermal recording device;

FIG. 2 is a front view of FIG. 1;

FIG. 3 is a front view of a platen roller;

FIG. 4(a) is a plan view of a reel table, and FIG. 4(b) is a front view of a reel spindle of the reel table;

FIG. 5 is an enlarged view of a first ridge;

FIGS. 6(a) and 6(b) are enlarged views of other first ridges;

FIGS. 7(a) and 7(b) are views showing how the first ridges of the reel table come into engagement with second ridges inside a take-up roller;

FIG. 8 is a perspective view of a conventional ink cartridge;

FIG. 9 is a perspective view of two rollers in the conventional ink cartridge;

FIG. 10 is a plan view in section of a device into which the conventional cartridge is to be inserted;

FIG. 11 is an enlarged side elevation of a conventional reel table;

FIG. 12 is a view of the conventional take-up roller as it is seen from the direction A in FIG. 10; and

FIG. 13 shows first ridges and second ridges in engagement therewith according to the prior art, (a) showing a proper state, and (b) showing a faulty state.

### DETAILED DESCRIPTION OF THE PREFERRED EMBODIMENT

An embodiment of the present invention will be described below in detail.

[Overall Construction]

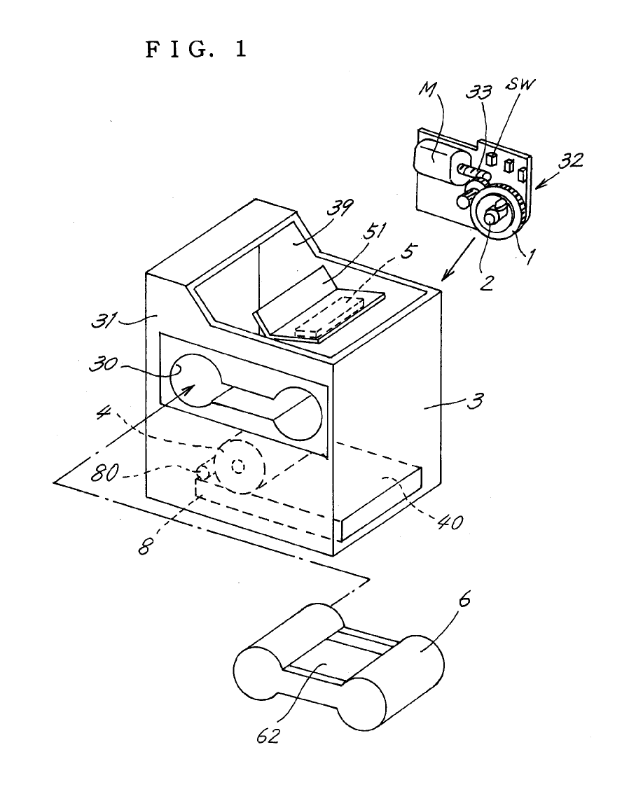

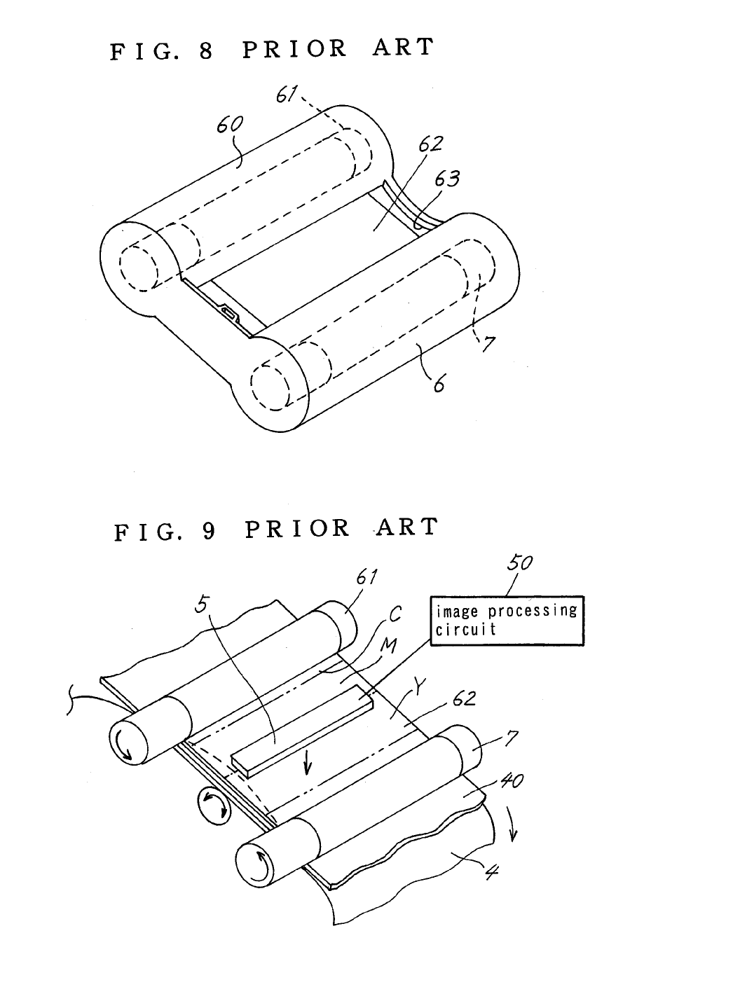

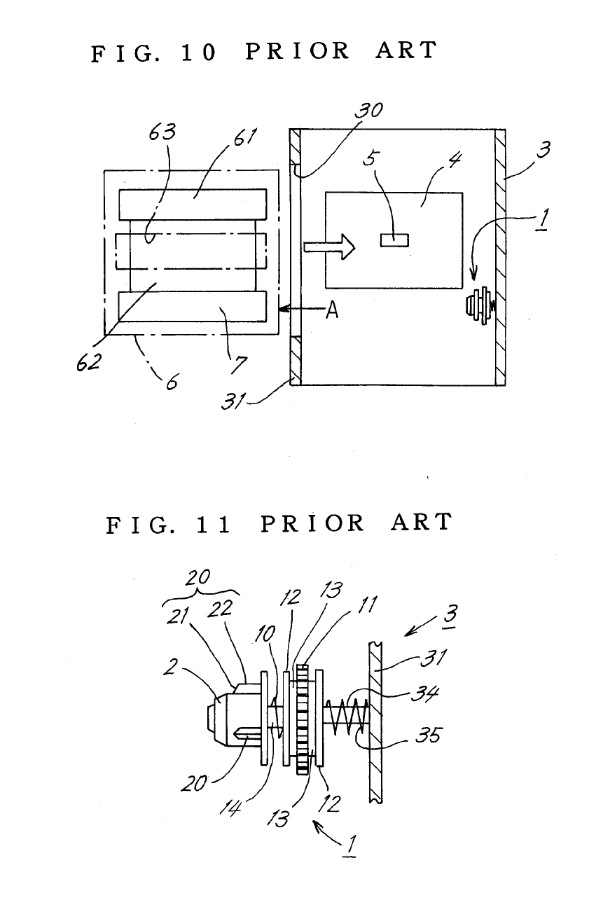

FIG. 1 is an exploded perspective view of a thermal recording device. The device has a main body 3 including a side plate 3 which has an opening 30 for inserting an ink cartridge 6 into the main body 3 therethrough. Arranged below the opening 30 are a platen roller 4 and a paper feed tray 8 for accommodating recording paper 40 therein. The ink cartridge 6 has generally the same interior construction as the one shown in FIG. 8.

Pivotally movably disposed inside the main body 3 is a support plate 51 positioned above the opening 30, provided with a thermal head 5 and serving also as a heat sink. As is well known, the thermal head 5 heats an ink sheet 62 inside the ink cartridge 6 to sublime inks and print images on the recording paper 40.

A take-up roller drive unit 32 provided with a reel table 1 is disposed in an interior rear portion of the main body 3. The drive unit 32 comprises a motor M and a train of gears 33 in mesh with the reel table 1. When energized, the motor M rotates the reel table 1. Mounted on the drive unit 32 is a switch SW for detecting the completion of insertion of the ink cartridge 6.

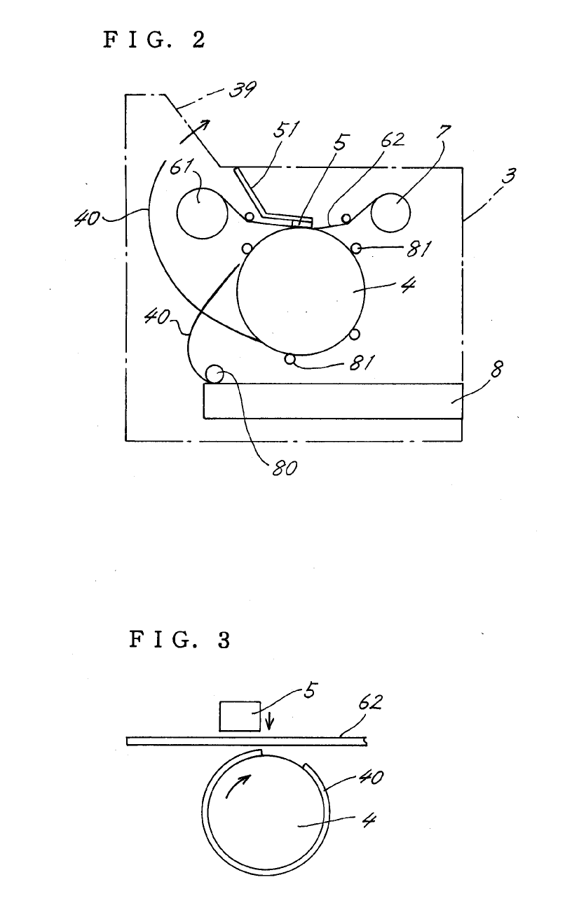

FIG. 2 is a front view of FIG. 1 and schematically shows the overall construction of the recording device. FIG. 3 is a front view of the platen roller 4. Sheets of the recording paper 40 inside the paper feed tray 8 are delivered therefrom one by one by a pickup roller 80. As in the prior art, the recording paper 40 is wound around the platen roller 4. With the platen roller 4 in rotation, the ink sheet 62 is transported by a take-up roller 7 while being heated by the thermal head 5 to print image data of yellow, magenta and cyan successively on the recording paper 40. On completion of printing, the resulting print is delivered by a transport roller 81 from an outlet 39 provided at an upper end portion of the main body 3.

[Details of Reel Table]

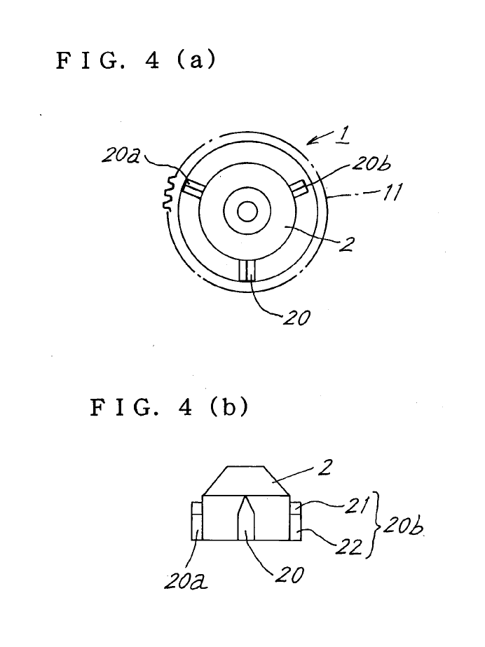

FIG. 4(a) is a plan view of the reel table 1, and FIG. 4(b) is a front view of a reel spindle 2 of the reel table 1. FIG. 4(b) shows the reel spindle 2 of FIG. 1 as positioned upright. Incidentally, the reel table 1 is the same as the conventional reel table 1 shown in FIG. 11 in overall construction, i.e., in that the reel table 1 comprises the reel spindle 2, compression spring 10 and take-up gear 11.

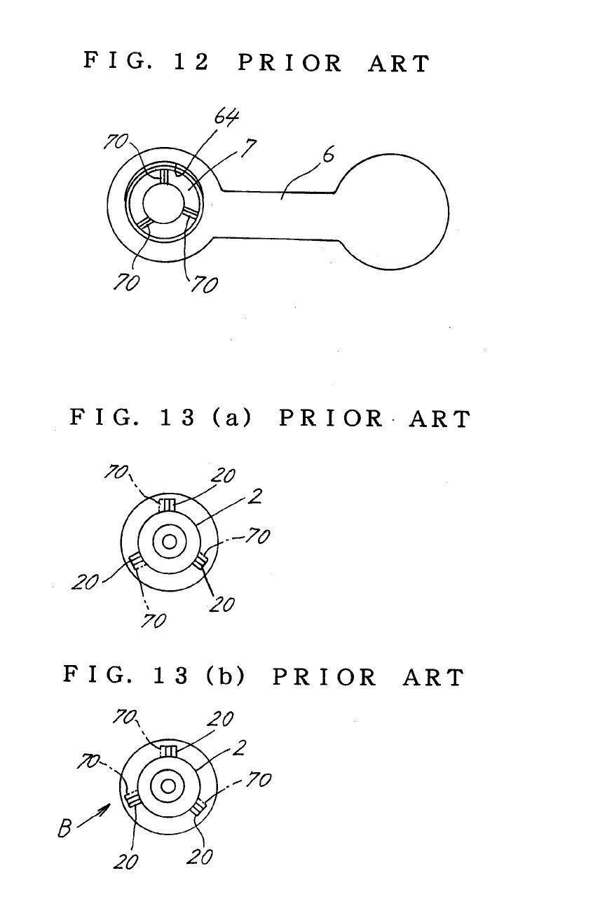

With reference to FIG. 4(b), the reel spindle 2 is provided on its peripheral surface with three first ridges 20, 20a, 20b engageable with respective second ridges 70, 70, 70 (see FIG. 12) inside the take-up roller 7. Each of the first ridges 20, 20a, 20b comprises a tapered end portion 21 having a sharp end, and a straight portion 22 integral with the tapered portion 21 and having a side face to be brought into contact with the take-up roller 7. All the first ridges 20, 20a, 20b are equal in the length Y1 of the straight portion 22.

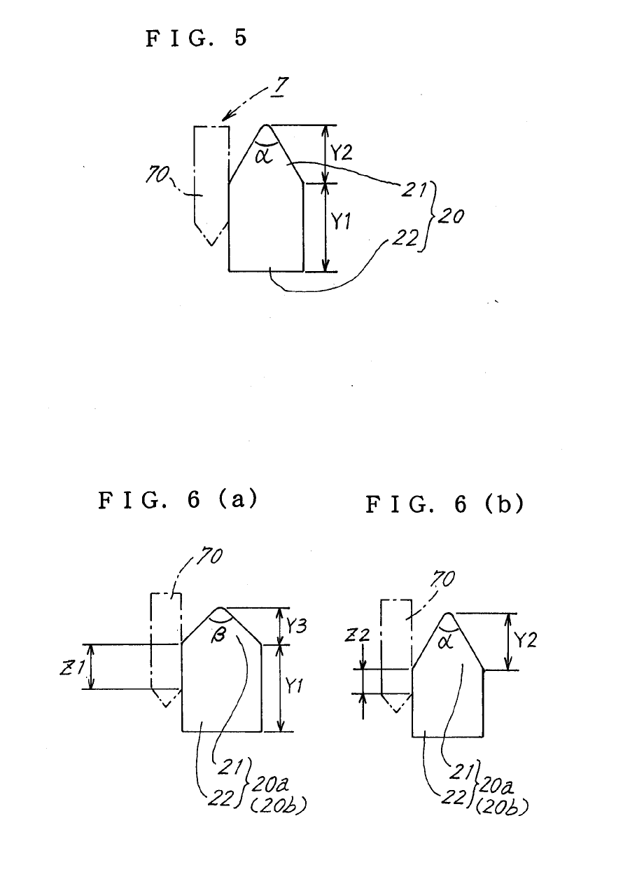

FIG. 5 and FIG. 6(a) are enlarged views of the first ridges 20, 20a, 20b. The tapered portion 21 of the first ridge 20 extending from the straight portion 22 thereof has a length of projection, i.e., a height, Y2 which is greater than the height Y3 of the tapered portions 21 of the other first ridges 20a, 20b. All the first ridges 20, 20a, 20b are equal in the length Y1 of the straight portion 22, and are also equal in width. Accordingly, the first ridge 20 has an acute angle α at the sharp end of its tapered portion 21, while the other first ridges 20a, 20b have an obtuse angle β at the sharp ends of their tapered portions 21.

If the first ridge 20a has an acute angle α at the sharp end of its tapered portion 21 as shown in FIG. 6(b), the straight portion 22 then has a shortened length. This reduces the length of engagement between the first ridge 20a and the second ridge 70 in the take-up roller 7, rendering the take-up roller 7 no longer rotatable with good stability. For this reason, all the first ridges 20, 20a, 20b are made equal in the length Y1 of the straight portion 22.

[Engagement of Reel Table with Take-up Roller]

When the ink cartridge 6 is inserted into the opening 30, the first ridges 20, 20a, 20b of the reel table 1 come into engagement with the respective second ridges 70, 70, 70 in the take-up roller 7. This movement will be described below.

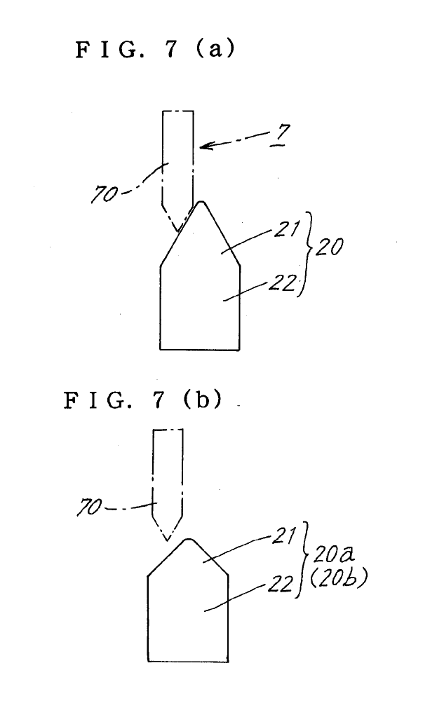

The tapered portion 21 of one of the first ridges, 20, which portion 21 is integral with the straight portion 22 thereof has a height Y2 greater than the height Y3 of the tapered portions 21 of the other first ridges 20a, 20b. Accordingly, when the tapered portion 21 of the first ridge 20 comes into contact with one of the second ridges 70 of the take-up roller 7 as shown in FIG. 7(a) upon insertion of the ink cartridge 6, the other first ridges 20a, 20b are still out of contact with the other second ridges 70 of the take-up roller 7 as shown in FIG. 7(b). The reel table 1 is slightly rotated by an amount corresponding to the backlash of the take-up gear 11 and the gear train 33 relative to each other, by the tapered portion 21 of the first ridge 20 coming into contact with the second ridge 70 of the roller 7 first.

When the ink cartridge 6 is further inserted, the side faces of the other first ridges 20a, 20b are properly brought into contact with the other second ridges 70 of the roller 7. Thus, the ridge 20 guides the take-up roller 7 so that the other ridges 20a, 20b come into proper engagement with the take-up roller 7. This brings the reel table 1 into proper engagement with the take-up roller 7 to properly transmit the rotation of the reel table 1 to the roller 7 and to ensure a stabilized winding-up operation.

Although the present embodiment has been described with reference to a thermal sublimation recording device as an example of thermal recording device, the invention can be embodied also as a thermal transfer recording device. The reel table 1 is not limited to use in thermal recording devices but may be used in magnetic recording devices such as video decks. The first ridges 20, 20a, 20b are not limited to three in number but can be at least four in number.

1. A reel table comprising a reel spindle opposed to a member to be engaged, the reel spindle being provided on a peripheral surface thereof with a plurality of ridges engageable with the member to be engaged, each of the ridges comprising a tapered end portion having a sharp end and a straight portion integral with the tapered portion and having a side face to be brought into contact with the member to be engaged,
the reel table being characterized in that one of the ridges is approximately equal to the other ridges in the length Y1 of the straight portion, the tapered portion of said one ridge integral with the straight portion having a height Y2 greater than the height Y3 of the tapered portions of the other ridges.

2. A recording device comprising a main body for inserting thereinto an ink cartridge having a take-up roller for winding up an ink sheet, and a reel table provided inside the main body and engageable with the take-up roller, the reel table being provided on a peripheral surface thereof with a plurality of ridges engageable with the take-up roller, each of the ridges comprising a tapered end portion having a sharp end and a straight portion integral with the tapered portion and having a side face to be brought into contact with the take-up roller,
the recording device being characterized in that one of the ridges is approximately equal to the other ridges in the length Y1 of the straight portion, the tapered portion of said one ridge integral with the straight portion having a height Y2 greater than the height Y3 of the tapered portions of the other ridges.
